(19) United States
(12) Patent Application Publication
(10) Pub. No.: US 2026/0071941 A1
(43) Pub. Date: Mar. 12, 2026

(54) ALCOHOL-FREE METHOD FOR PREPARATION OF DRY TISSUE

(71) Applicant: MiRus LLC, Marietta, GA (US)

(72) Inventors: Md Tausif Salim, Decatur, GA (US); Samuel Beckett Gookin, Marietta, GA (US)

(21) Appl. No.: 19/311,062

(22) Filed: Aug. 27, 2025

Related U.S. Application Data
(60) Provisional application No. 63/691,517, filed on Sep. 6, 2024.

(51) Int. Cl. G01N 1/30; G01N 1/28; G01N 1/34

(52) U.S. Cl. CPC G01N 1/30; G01N 1/286; G01N 1/34; G01N 2001/2873; G01N 2001/305

(57) ABSTRACT

A method of preparing tissue components includes a) providing tissue, b) optionally cleaning the tissue, c) exposing the tissue to a fixation solution, d) optionally exposing the tissue to a bioburden reduction solution, e) optionally exposing the tissue to an anti-calcification solution, f) exposing the tissue to a dimensional stabilizer solution, g) applying a thickening agent or alcohol to the tissue, h) optionally removing the thickening agent or alcohol from the tissue, i) optionally storing the treated tissue in a packaging or a container that is absent a liquid solution, and j) subjecting the packaged, container and/or tissue to a sterilization process.

### REFERENCED APPLICATIONS

The present application claims priority on U.S. Provisional Patent Application Ser. No. 63/691,517 filed Sep. 6, 2024, which is fully incorporated herein by reference.

### FIELD OF DISCLOSURE

The disclosure relates generally to medical devices and medical device applications, particularly to a process for the treatment of collagenous tissue to adapt it for use in a prosthetic implant, and more particularly to a process for the treatment of collagenous tissue to adapt it for use in a prosthetic implant that includes a) providing an animal tissue component; b) treating the tissue component with a treatment solution that includes a dimensional stabilizer; c) removing the treated tissue from the treatment solution; d) applying a thickening agent to the treated tissue; e) mechanically removing thickening agent from the treated tissue; f) storing the treated tissue component in a container without solution, and g) sterilizing the treated tissue.

### BACKGROUND OF DISCLOSURE

Many cardiovascular devices such as expandable heart valves, and the like are inserted into a patient via the vascular system of a patient and then expanded at the treatment site. These devices are typically crimped onto a catheter prior to insertion into a patient.

Medical devices such as Transcatheter aortic valves (TAVs) represent a significant advancement in prosthetic heart valve technology. TAVs bring the benefit of heart valve replacement to patients that would otherwise not be operated on. Transcatheter aortic valve replacement (TAVR) can be used to treat aortic valve stenosis in patients who are classified as high-risk for open heart surgical aortic valve replacement (SAVR). Non-limiting TAVs are disclosed in U.S. Pat. Nos. 5,411,522; 6,730,118; 10,729,543; 10,820,993; 10,856,970; 10,869,761; 10,952,852; 10,980,632; 10,980,633; and US Pub. No. 2020/0405482, all of which are incorporated fully herein by reference.

A TAV is designed to be compressed into a small diameter catheter, remotely placed within a patient's diseased aortic valve to take over the function of the native valve. Some TAVs are balloon-expandable, while others are self-expandable. In both cases, the TAVs are deployed within a calcified native valve that is forced permanently open and becomes the surface against which the frame is held in place by friction. TAVs can also be used to replace failing bioprosthetic or transcatheter valves, commonly known as a valve in valve procedure. Major TAVR advantages to the traditional surgical approaches include refraining from cardiopulmonary bypass, aortic cross-clamping and sternotomy which significantly reduces patients' morbidity.

The TAV includes a plurality of leaflets that are important to the proper functioning of the TAV after implantation. As such, the durability and longevity of the leaflets is important in improving the life of the TAV. It is common practice to treat the leaflets with glutaraldehyde. Although such glutaraldehyde treated leaflets have demonstrated long-term durability, the tissue formed leaflets still experience tissue-fatigue and a propensity toward calcification which shortens the useful life of the leaflets.

Typically, the animal tissues used to form the leaflets of implantable devices are chemically treated with agents such as glutaraldehyde. Such treatment is useful to prevent rejection of the implanted device in the patient. Such treatment also stabilizes the protein components of the animal tissue components of the leaflets, making them more resistant to degradation by proteolytic enzymes. Typically tissue treatments include chemical fixation of tissue to stabilize the structure for long-term implantation purposes. The chemical fixation process is commonly by exposing the tissue to glutaraldehyde and formaldehyde. Another tissue treatment process is commonly used to mitigate calcium deposition onto the tissue after the tissue has been implanted in a patient. Such calcium mitigation treatment process can be performed before or after the chemical fixation of the tissue. Common calcium mitigation treatment process includes the use of alcohol rinses (ethanol, isopropanol, etc.) on the tissue, forming crosslinking bonds in the tissue using reducing agents such as sodium borohydride), capping of residual aldehyde residues in the tissue using ethanolamine, jeffamine, AOA, etc., and other means. The tissue can also be subjected to a bioburden reduction treatment to minimize microbial load. Such treatments include exposing the tissue to a solution comprised of a fixative (e.g., formaldehyde), a denaturant (e.g., ethanol), and a surfactant (e.g., TWEEN 80). The tissue can also be subjected to a dimensional stabilization process which can be achieved by replacing the water content of the tissue interstices with a stable organic compound such as polyols (e.g., glycerol, ethylene glycol, etc.) that are stable in atmospheric conditions. The polyols can be pure polyols, aqueous solutions of polyols, and polyols diluted with alcohols (e.g., ethanol, isopropanol, etc.). If a dimensional stabilization solution is applied to the tissue, the dimensional stabilization solution is removed from the tissue. Polyols are highly viscous compounds that coat the surface of the tissue component. Alcohol rinses of various composition, concentration, and exposure duration are commonly used to remove the dimensional stabilization solution from the tissue. However, alcohol-based rinses run the risk of dehydrating and potentially damaging the tissue construct. Alcohol solutions diluted in water run the risk of partially impregnating the tissue construct with water again. After rinsing of the tissue, the processed tissue is packaged in an air environment. Such packaging generally includes placing the processed tissue in a Tyvek/poly pouch or other sealed container that can then undergo subsequent sterilization. Once the tissue is packaged, the tissue and packaging are subjected to terminal sterilization. Typically, ethylene oxide (EO) gas is used during the sterilization process. Gamma irradiation (y irradiation), vaporized Hydrogen Peroxide (VPH), electron beam (e-beam), and X-Ray irradiation are alternative methods used for sterilization. Gamma irradiation and E-beam generates high heat, which can degrade the tissue. VPH breaks down into water and oxygen, and wherein water exposure to the tissue may adversely affect the hydrated state of tissue.

Many tissue treatment process have been proposed to extend the life of the processed tissue. Some of these treatment processes are disclosed in U.S. Pat. Nos. 4,553,974; 4,648,881; 4,885,505; 5,188,834; 6,534,004; 7,622,276; 8,007,992; and 8,632,608, all of which are incorporated in their entirety herein by reference.

In view of the current state of treating animal tissue for use as leaflets in prosthetic valves, there is a need for an improved treatment process that extends the longevity of the leaflets in prosthetic valves.

### SUMMARY OF THE DISCLOSURE

The present disclosure is directed to a method for the treatment of tissue for use in a prosthetic valve. Non-limiting prosthetic valves includes heart valve, TAVR valve, aortic valve, mitral valve, tricuspid valve, pulmonary valve, etc. In one non-limiting embodiment, the prosthetic valve (e.g., heart valve, TAVR valve, mitral valve replacement, tricuspid valve replacement, pulmonary valve replacement, etc.) includes a radially collapsible and expandable frame and a leaflet structure that comprises a plurality of leaflets. In another non-limiting embodiment, the prosthetic valve optionally includes an annular skirt or cover member that is disposed on and partially or fully covering or overlaid over at least a portion of the frame.

In one non-limiting aspect of the present disclosure, the frame or the prosthetic valve can be partially or fully formed of a) a refractory metal alloy, b) a metal alloy that includes at least 15 atomic weight percent (awt. %) or atomic percent (awt. %) rhenium, c) stainless steel, d) CoCr alloy, e) TiAlV alloy, f) aluminum alloy, g) nickel alloy, h) titanium alloy, i) tungsten alloy, j) molybdenum alloy, k) copper alloy, l) beryllium-copper alloy, m) titanium-nickel alloy, or n) metal alloy (e.g., stainless steel, CoCr alloy, TiAlV alloy, aluminum alloy, nickel alloy, titanium alloy, tungsten alloy, molybdenum alloy, copper alloy, beryllium-copper alloy, titanium-nickel alloy, refractory metal alloy, etc.) that includes at least 5 atomic weight percent (awt. %) or atomic percent (awt. %) rhenium (e.g., 5-99 awt. % rhenium and all values and ranges therebetween).

In accordance with another and/or alternative non-limiting aspect of the present disclosure, the prosthetic valve optionally includes an inner skirt, and wherein the inner skirt can be formed of a variety of flexible materials (e.g., polymer [e.g., polyethylene terephthalate (PET), polyester, nylon, Kevlar®, silicon, etc.], composite material, metal, fabric material, etc.). In one non-limiting embodiment, the material used to partially or fully form the inner skirt can optionally be substantially non-elastic (i.e., substantially non-stretchable and non-compressible). In another non-limiting embodiment, the material used to partially or fully form the inner skirt can optionally be a stretchable and/or compressible material (e.g., silicone, PTFE, ePTFE, polyurethane, polyolefins, hydrogels, biological materials [e.g., pericardium or biological polymers such as collagen, gelatin, or hyaluronic acid derivatives], etc.). The inner skirt can optionally be formed from a combination of a cloth or fabric material that is coated with a flexible material or with a stretchable and/or compressible material so as to provide additional structural integrity to the inner skirt. The size, configuration, and thickness of the inner skirt is non-limiting (e.g., thickness of 0.1-20 mils and all values and ranges therebetween). The inner skirt can be secured to the inside and/or outside of the frame using various means (e.g., sutures, clamp arrangement, etc.). In another non-limiting embodiment, the inner skirt can be made out of a woven material; however, non-woven materials can also or alternatively be used. In another non-limiting embodiment, the inner skirt (when used) can be used to 1) at least partially seal and/or prevent perivalvular leakage, 2) at least partially secure the leaflet structure to the frame, 3) at least partially protect the leaflets from damage during the crimping and/or expansion process, and/or 4) at least partially protect the leaflets from damage during the operation of the prosthetic valve in the heart.

In accordance with another and/or alternative non-limiting aspect of the present disclosure, the prosthetic valve optionally includes an outer or sleeve that is positioned at least partially about the exterior region of the frame. The outer skirt or sleeve generally is positioned completely around a portion of the outside of the frame. Generally, the outer skirt is positioned about the lower portion of the frame, but does not fully cover the upper half of the frame; however, this is not required. The outer skirt can be connected to the frame by a variety of arrangements (e.g., sutures, adhesive, melted connection, clamping arrangement, etc.). At least a portion of the outer skirt can optionally be located on the interior surface of the frame. Generally, the outer skirt is formed of a more flexible and/or compressible material than the inner skirt; however, this is not required. The outer skirt can be formed of a variety of a stretchable and/or compressible material (e.g., silicone, PTFE, ePTFE, polyurethane, polyolefins, hydrogels, biological materials [e.g., pericardium or biological polymers such as collagen, gelatin, or hyaluronic acid derivatives], etc.). The outer skirt can optionally be formed from a combination of a cloth or fabric material that is coated with the stretchable and/or compressible material to provide additional structural integrity to the outer skirt. In another non-limiting embodiment, the outer skirt can be made out of a woven material; however, non-woven materials can also or alternatively be used. The size, configuration, and thickness of the outer skirt is non-limiting. The thickness of the outer skirt is generally 0.1-20 mils (and all values and ranges therebetween).

In accordance with another and/or alternative non-limiting aspect of the present disclosure, the prosthetic valve includes a leaflet structure that can be attached to the frame and/or skirt. The connection arrangement used to secure the leaflet structures to the frame and/or skirt is non-limiting (e.g., sutures, melted bold, adhesive, clamp arrangement, etc.). The material used to form the leaflet structures can include animal tissue (e.g., bovine pericardial tissue, bovine tissue, porcine tissue, etc.), human tissue, etc. In one non-limiting embodiment, the leaflet structure comprised of two or more leaflets (e.g., 2, 3, 4, 5, 6, etc.). In one non-limiting arrangement, the leaflet structure includes three leaflets arranged to collapse in a tricuspid arrangement. The configuration of the leaflet structures is non-limiting. In another non-limiting embodiment, the leaflets of the leaflet structure can optionally be secured to one another at their adjacent sides to form commissures of the leaflet structure (the edges where the leaflets come together). The leaflet structure can be secured together by a variety of connection arrangement (e.g., sutures, adhesive, melted bond, clamping arrangement, etc.). In another non-limiting embodiment, one or more of the leaflets can optionally include reinforcing structures or strips to 1) facilitate in securing the leaflets together, 2) facilitate in securing the leaflets to the skirt and/or frame, and/or 3) inhibit or prevent tearing or other types of damage to the leaflets.

In accordance with another and/or alternative non-limiting aspect of the present disclosure, the frame of the prosthetic valve can optionally be partially (e.g., 1% to 99.99% and all values and ranges therebetween) or fully be coated with and/or include one or more agents. When one or more agents are coated on the prosthetic valve, and the prosthetic valve includes an enhancement layer, one or more agents are generally coated on the outer surface of the enhancement layer. The term “agent” includes, but is not limited to a substance, pharmaceutical, biologic, veterinary product, drug, and analogs or derivatives otherwise formulated and/or designed to prevent, inhibit and/or treat one or more clinical and/or biological events, and/or to promote healing. Non-limiting examples of clinical events that can be addressed by one or more agents include, but are not limited to, viral, fungus and/or bacterial infection; vascular diseases and/or disorders; lymphatic diseases and/or disorders; cancer; implant rejection; pain; nausea; swelling; organ failure; immunity diseases and/or disorders; cell growth inhibitors, blood diseases and/or disorders; heart diseases and/or disorders; neuralgia diseases and/or disorders; fatigue; genetic diseases and/or disorders; trauma; cramps; muscle spasms; tissue repair; nerve repair; neural regeneration and/or the like.

In another and/or alternative non-limiting aspect of the disclosure, the frame of the prosthetic valve can optionally include a marker material that facilitates enabling the frame for a prosthetic valve to be properly positioned in a body passageway. The marker material is typically designed to be visible to electromagnetic waves (e.g., x-rays, microwaves, visible light, infrared waves, ultraviolet waves, etc.); sound waves (e.g., ultrasound waves, etc.); magnetic waves (e.g., MRI, etc.); and/or other types of electromagnetic waves (e.g., microwaves, visible light, infrared waves, ultraviolet waves, etc.).

In accordance with another and/or alternative non-limiting aspect of the present disclosure, the frame of the prosthetic valve, one or more leaflets, the inner skirt, and/or the outer skirt can be partially (e.g., 1% to 99.99% and all values and ranges therebetween) or fully be coated with an enhancement layer to improve one or more properties of the prosthetic valve (e.g., change exterior color of material having coated surface, increase surface hardness by use of the coated surface, increase surface toughness material having coated surface, reduced friction via use of the coated surface, improve scratch resistance of material that has the coated surface, improve impact wear of coated surface, improve resistance to corrosion and oxidation of coated material, form a non-stick coated surface, improve biocompatibility of material having the coated surface, reduce toxicity of material having the coated surface, reduce ion release from material having the coated surface, the enhancement layer forms a surface that is less of an irritant to cell about the coated surface after the frame for a prosthetic valve is implanted, promote nitric oxide formation on the surface of the coating, reduces bacterial growth and/or bacterial infection about the implanted prosthetic heart valve, reduce neointimal hyperplasia, reduce tissue proliferation, reduce platelet activation, reduce thrombosis, reduce restenosis, promote endothelial cell angiogenesis, stimulate endothelial cells, promote modulation of endothelial cells, reduce irritation to the cells about the expanded prosthetic valve, reduce and/or slow the growth rate of cells from the heart onto the frame and/or leaflets of the prosthetic valve, etc. Non-limiting coating compositions that can form a portion or all of the enhancement layer include chromium nitride (CrN), diamond-like carbon (DLC), titanium nitride (TiN), titanium nitride oxide (TiNOx), zirconium nitride (ZrN), zirconium oxide (ZrO₂), zirconium-nitrogen-carbon (ZrNC), zirconium OxyCarbide (ZrOC), zirconium oxynitride (ZrNxOy) [e.g., cubic ZrN:O, cubic ZrO₂:N, tetragonal ZrO₂:N, and monoclinic ZrO₂:N phase coatings], and combinations of such coatings. The enhancement layer can include a metal adhesion layer (e.g., titanium, titanium alloy, zirconium, zirconium alloy, etc.) that facilitates in the binding of the coating composition to one or more regions of the prosthetic valve.

In accordance with another and/or alternative non-limiting aspect of the present disclosure, there is provided a method for treating tissue to inhibit post implant calcification. The method is particularly useful in treating tissue for use in the forming of leaflets of heart valves. However, it will be appreciated that the tissue treatment process can be used on tissues for other applications. For example, the treated tissue can be used in heart valves; venous valves; blood vessels; ureter; tendon; dura mater; skin; pericardium; cartilage (e.g., meniscus); ligament; bone; intestine (e.g., intestinal wall); small intestinal submucosa (“SIS tissue”), and periostium. As such, the treated tissued can be used in various procedures such as a) the surgical replacement of diseased heart valves with prosthetic heart valves that includes the treated tissue, b) the repair or bypassing of blood vessels by implanting biological vascular grafts that include the treated tissue, c) the surgical replacement or repair of torn or deficient ligaments by implanting bioprosthetic ligaments that include the treated tissue, d) the repair, reconstruction, reformation, enhancement, bulking, ingrowth, reconstruction or regeneration of native tissues by implanting one or more biopolymeric or bioprosthetic tissue scaffolds that include the treated tissue, etc. The tissue can be obtained from a human cadaver or animal donor, and prepared for subsequent fixation and treatment. The tissue is typically harvested by surgical cutting or removal from its human cadaver or host animal. Thereafter, the tissue is typically trimmed or cut to size and optionally washed with sterile water, basic salt solution, saline or other suitable washing solution.

In accordance with another and/or alternative non-limiting aspect of the present disclosure, there is provided a method for treating tissue that includes a) providing tissue (e.g., animal tissue, human tissue, etc.), b) optionally cleaning the tissue, c) exposing the tissue to a fixation solution, d) optionally exposing the tissue to a bioburden reduction solution, e) optionally exposing the tissue to an anti-calcification solution, f) exposing the tissue to a dimensional stabilizer solution, g) applying a thickening agent or alcohol to the tissue, h) optionally removing the thickening agent or alcohol from the tissue, i) optionally storing the treated tissue in a packaging or a container that is absent a liquid solution, and j) subjecting the packaged, container and/or tissue to a sterilization process. In one non-limiting embodiment, one non-limiting tissue processing method includes a) providing tissue (e.g., animal tissue, human tissue, etc.), b) optionally cleaning the tissue, c) exposing the tissue to a fixation solution, d) optionally exposing the tissue to a bioburden reduction solution, e) optionally exposing the tissue to an anti-calcification solution, f) exposing the tissue to a dimensional stabilizer solution, g) applying alcohol to the tissue, h) optionally removing the alcohol from the tissue, i) optionally storing the treated tissue in a packaging or a container that is absent a liquid solution, and j) subjecting the packaged, container and/or tissue to a sterilization process. In another non-limiting embodiment, another non-limiting tissue processing method includes a) providing tissue (e.g., animal tissue, human tissue, etc.), b) optionally cleaning the tissue, c) exposing the tissue to a fixation solution, d) optionally exposing the tissue to a bioburden reduction solution, e) optionally exposing the tissue to an anti-calcification solution, f) exposing the tissue to a dimensional stabilizer solution, g) applying a thickening agent to the tissue, h) optionally removing the thickening agent from the tissue, i) optionally storing the treated tissue in a packaging or a container that is absent a liquid solution, and j) subjecting the packaged, container and/or tissue to a sterilization process.

In accordance with another and/or alternative non-limiting aspect of the present disclosure, the source of tissue that can be processed is non-limiting. Non-limiting types of tissue that can be used include bovine pericardium tissue; porcine, bovine, ovine, or other aortic or pulmonary valves and vascular tissues; human donor allografts; other sources of connective tissue matrices, including porcine, equine, ovine and other xenogeneic or allogeneic pericardial tissues; dura mater; omentum or other tissues of the digestive tract; skin, placenta, uterus, or tissues reconstructed in vitro from cells from such tissues; and ocular tissues including cornea and sclera. The processed tissue can be used in various types of medical device such as, but not limited to, heart valves and valve leaflets; vascular grafts for peripheral, coronary and dialysis assess; patches, strips, or buckles used to reinforce or repair soft tissues, hard tissues, cartilage, tendon, cornea, or the like for organ repair and reinforcement for effective reconstruction procedures (including native valve reconstruction, valve annuloplasty and repair).

In accordance with another and/or alternative non-limiting aspect of the present disclosure, the tissue can be optionally cleaned by rinsing the tissue one or more times (e.g., 1-5 times, etc.) in distilled water and/or a saline solution. Prior to or after the cleaning of the tissue, the tissue can be cut to a desired size for further processing.

In accordance with another and/or alternative non-limiting aspect of the present disclosure, the fixation solution is or includes glutaraldehyde. The fixation solution is used to stabilize the structure of the tissue for long-term implantation purposes. Generally, the tissue is exposed to the fixation solution for 5 minutes to 48 hours (and all values and ranges therebetween); however, longer exposure times can be used. The temperature of the fixation solution that is used on the tissue can be 4° C.-45° C. (and all values and ranges therebetween). The relative humidity about the tissue during the fixation step can be 5%-95% (and all values and ranges therebetween). Non-limiting examples of fixation solutions include a) pure glutaraldehyde, or b) a glutaraldehyde solution, which solution can include one or more of saline, phosphate buffered saline, surfactants (e.g. Tween® 80), ethanol, aldehydes (e.g., formaldehyde, glutaraldehyde, dialdehyde starch), polyglycidyl ethers (e.g., Denacol 810), and/or heterologous bifunctional or multifunctional crosslinkers. One non-limiting fixation solution includes glutaraldehyde and formaldehyde. The tissue is generally exposed to the fixation solution for a sufficient time period to equilibrate within the interstices of the tissue. As can be appreciated, the tissue can be exposed to the fixation solution in a single step, or can be exposed to the fixation solution two of more times (e.g., expose tissue to fixation solution, then remove tissue from the fixation solution, and then reexpose tissue to the fixation solution, and optionally rinsing the tissue after being remove from the fixation solution and prior to being reexposed to the fixation solution, etc.). After the tissue has been exposed to the fixation solution, the tissue can be optionally rinsed one or more times (e.g., 1-5 times, etc.). Such rinsing solution can include, but is not limited to, distilled water and/or saline.

In accordance with another and/or alternative non-limiting aspect of the present disclosure, the optional bioburden reduction step includes exposing the tissue to a bioburden solution of i) a crosslinking agent (e.g., aldehydes, epoxies, carbodiimides, etc.), ii) a denaturing agent (e.g., alcohols, acidified ethers, ketones, glycols, etc.) and iii) a surfactant (e.g., anionic surfactants, alkyl sulfonic acid salts, alkylated phenoxypolyethoxy alcohols, Triton X-IOO, 114, 405, N-101, etc.). Non-limiting bioburden reduction solution is disclosed in U.S. Pat. Nos. 4,885,005, 4,648,881, and 8,632,608 which are fully incorporated herein by reference. In one non-limiting embodiment, the bioburden reduction solution is a mixture of formaldehyde (e.g., 3-5 wt. %), ethanol (e.g., 19-25 wt. %), surfactant (e.g., Tween® 80 surfactant) (e.g., 0.8-2 wt. %) and the balance water. The tissue is generally exposed to the bioburden reduction solution for 15 minutes to 2 weeks (and all values and ranges therebetween). The temperature of the bioburden reduction solution that is used on the tissue can be 4° C.-45° C. (and all values and ranges therebetween). The relative humidity about the tissue during the bioburden reduction step can be 5%-95% (and all values and ranges therebetween). Generally, the composition of the bioburden reduction solution is different from the fixation solution. As can be appreciated, the tissue can be exposed to the bioburden reduction solution in a single step, or can be exposed to the bioburden reduction solution two of more times (e.g., expose tissue to bioburden reduction solution, then remove tissue from the bioburden reduction solution, and then reexpose tissue to the bioburden reduction solution, and optionally rinse the tissue after being removed from the bioburden reduction solution and prior to being reexposed to the bioburden reduction solution, etc.). After the completion of the bioburden reduction step, the tissue can be rinsed one or more times (e.g., 1-5 times) with a saline solution and/or distilled water or some other type of rinsing solution. The bioburden reduction step is used to minimize the microbial load of the tissue.

In accordance with another and/or alternative non-limiting aspect of the present disclosure, the tissue is optionally exposed to an anti-calcification treatment. The anti-calcification treatment is used to mitigate calcium deposition onto the tissue. The anti-calcification treatment performed before or after the step of exposing the tissue to the fixation solution. The anti-calcification treatment includes the step of a) exposing the tissued to one or more solutions that include alcohol rinses (ethanol, isopropanol, etc.), b) directing chemistry of crosslinking bonds in the tissue by exposure to reducing agents (e.g., sodium borohydride, etc.), and/or c) capping of residual aldehyde residues in the tissue by exposure to capping solutions (e.g., ethanolamine, jeffamine, AOA, etc.). The tissue is exposed to the anti-calcification solution for 15 minutes to 48 hours (and all values and ranges therebetween). The temperature of the anti-calcification solution that is used on the tissue can be 4° C.-45° C. (and all values and ranges therebetween). The relative humidity about the tissue during the anti-calcification step can be 5%-95% (and all values and ranges therebetween). As can be appreciated, the tissue can be exposed to the anti-calcification solution in a single step, or can be exposed to the anti-calcification solution two of more times (e.g., exposed tissue to anti-calcification solution, then remove tissue from the anti-calcification solution, and then reexpose tissue to the anti-calcification solution, and optionally rinsing the tissue after being removed from the anti-calcification solution and prior to being reexposed to the anti-calcification solution, etc.). After the tissue has been exposed to the anti-calcification treatment, the tissue can be exposed to one or more rinses with distilled water, saline solution, or some other type of rinsing solution.

In accordance with another and/or alternative non-limiting aspect of the present, the tissue is optionally exposed to a dimensional stabilization treatment (also referred to as a Glycerol Incubation). The dimensional stabilization of the tissue is achieved via replacing the water content of the tissue interstices with a stable organic compound. During the dimensional stabilization treatment, the tissue is exposed to a solution that includes polyols (e.g., glycerol, ethylene glycol, etc.) that are stable in atmosphere. The solution can be formed of pure polyols, aqueous solutions of polyols, and polyols diluted with alcohols (e.g., ethanol, isopropanol, etc.). In one non-limiting embodiment, the composition of the dimensional stabilization solution is 5-100 vol. % of one or more polyols (and all values and ranges therebetween), 0-60 vol. % distilled water (and all values and ranges therebetween), and 0-60 vol. % of one or more alcohols (and all values and ranges therebetween). In another non-limiting embodiment, the composition of the dimensional stabilization solution is 5-100 vol. % glycerol (and all values and ranges therebetween), 0-60 vol. % distilled water (and all values and ranges therebetween), and 0-60 vol. % alcohol (and all values and ranges therebetween). The tissue is exposed to the dimensional stabilization solution for a time sufficient to equilibrate within the interstices of the tissue. In one non-limiting embodiment, the tissue is exposed to the dimensional stabilization solution for 15 minutes to 72 hours (and all values and ranges therebetween). The temperature of the dimensional stabilization solution that is used on the tissue can be 4° C.-45° C. (and all values and ranges therebetween). The relative humidity about the tissue during the dimensional stabilization step can be 5%-95% (and all values and ranges therebetween). As can be appreciated, the tissue can be exposed to the dimensional stabilization solution in a single step, or can be exposed to the dimensional stabilization solution two of more times (e.g., exposed tissue to dimensional stabilization solution, then remove tissue from the dimensional stabilization solution, and then reexpose tissue to the dimensional stabilization solution, and optionally rinsing the tissue after being removed from the dimensional stabilization solution and prior to being reexposed to the dimensional stabilization solution, etc.). After the tissue has been exposed to the dimensional stabilization solution for a desired period of time, the dimensional stabilization solution is removed from the tissue. In one non-limiting embodiment, the removal of the dimensional stabilization solution from the tissue is accomplished with the use of alcohols or water.

In accordance with another and/or alternative non-limiting aspect of the present disclosure, the tissue is optionally exposed to Ethanol Incubation. The Ethanol Incubation step is an alternative step to the step of exposing the tissue to a thickening agent. As can be appreciated, the Ethanol Incubation solution used in the Ethanol Incubation step can be 100% ethanol, a portion ethanol and one or more other types of alcohols (e.g., isopropanol, etc.), or one or more alcohols that does not include ethanol. In one non-limiting embodiment, the tissue is exposed to the Ethanol Incubation solution for 1 second to 12 hours (and all values and ranges therebetween). The temperature of the Ethanol Incubation solution that is used on the tissue can be 4° C.-45° C. (and all values and ranges therebetween). The relative humidity about the tissue during the Ethanol Incubation step can be 5%-95% (and all values and ranges therebetween). As can be appreciated, the tissue can be exposed to the Ethanol Incubation solution in a single step, or can be exposed to the Ethanol Incubation solution two of more times (e.g., exposed tissue to Ethanol Incubation solution, then remove tissue from the Ethanol Incubation solution, and then reexpose tissue to the Ethanol Incubation solution).

In accordance with another and/or alternative non-limiting aspect of the present disclosure, the tissue is optionally exposed to a thickening agent. When the tissue is exposed to the thickening agent, the step of Ethanol Incubation can be eliminated; however, this is not required. Generally, the thickening agent is applied to the tissue after the dimensional stabilization step; however, the thickening agent can be added to the dimensional stabilization solution while the tissue is in the dimensional stabilization. When the thickening agent is added to the dimensional stabilization solution while the tissue in in the dimensional stabilization, the thicken agent is generally added to the dimensional stabilization solution after the dimensional stabilization solution has equilibrated within the interstices of the tissue; however, this is not required. The thickening agent is generally applied to a portion or all of the outer surface of the tissue. The thickening agent is used to remove a portion or all of prior solution treatments that remain on the tissue without use of solutions that include alcohols and/or water. Polyols that are used in the dimensional stabilization solution are highly viscous and coat the surface of the tissue. Generally, alcohol rinses of various composition, concentration, and duration were used to remove residual polyols from the tissue. However, alcohol-based rinses run the risk of dehydrating and potentially damaging the tissue. Also, alcohol solutions diluted in water run the risk of partially impregnating the tissue with water. The use of the thickening agent overcomes this past tissue processing limitations. The application of a thickening agent to the surface of the tissue is used to remove any residual polyols from the tissue without the need of alcohols or alcohol solutions. The thickening agent can include polysaccharides (e.g., maltodextrin powder, maltodextrin (d-glucose polysaccharide), guar gum (galactomannan polysaccharide), pectin (heteropolysaccharide), starches, etc.). During the exposure of the tissue to the thickening agent can be used in combination with alcohol and/or water. After the tissue has been exposed to the thickening agent, the thickening agent is mechanically removed from the tissue.

In accordance with another and/or alternative non-limiting aspect of the present disclosure, the tissue is optionally stored in a container or package after the removal of the thickening agent from the tissue. Generally, the container or packaging is absent any solution, thus the tissue is dry packed in the container or packaging. Non-limiting packaging includes Tyvek/poly pouches.

In accordance with another and/or alternative non-limiting aspect of the present disclosure, the tissue is optionally sterilized prior to, during and/or after being stored in a container or packaging. In one non-limiting embodiment, the tissue is sterilized by the use of a sterilization gas (e.g., ethylene oxide, etc.). As can be appreciated, other or alternative sterilization processes can be use. In one non-limiting embodiment, the sterilization of the tissue, packaging and/or container is accomplished with use of a liquid material.

One non-limiting object of the present disclosure is the provision of a method for treating tissue that includes a) providing tissue (e.g., animal tissue, human tissue, etc.), b) cleaning the tissue, c) expose the tissue to a fixation solution, d) optionally exposing the tissue to a bioburden reduction, e) optionally exposing the tissue to an anti-calcification treatment, f) treating the tissue with an treatment solution that includes a dimensional stabilizer, g) applying a thickening agent to the tissue, h) optionally removing the thickening agent, i) optionally storing the treated tissue in a packaging to a container without solution, and j) subjecting the packaged, container and/or tissue to a sterilization process.

Another non-limiting object of the present disclosure is the provision of a method for treating tissue that includes a) providing tissue (e.g., animal tissue, human tissue, etc.), b) optionally cleaning the tissue, c) exposing the tissue to a fixation solution, d) optionally exposing the tissue to a bioburden reduction solution, e) optionally exposing the tissue to an anti-calcification solution, f) exposing the tissue to a dimensional stabilizer solution, g) applying a thickening agent or alcohol to the tissue, h) optionally removing the thickening agent or alcohol from the tissue, i) optionally storing the treated tissue in a packaging or a container that is optionally absent a liquid solution, and j) subjecting the packaged, container and/or tissue to a sterilization process that optionally does not include a liquid.

Another non-limiting object of the present disclosure is the provision of a method for treating tissue wherein the treatment of the tissue reduces directional heterogeneity in material properties of the tissue as compared to tissue treated by prior art processes.

Another non-limiting object of the present disclosure is the provision of a method for treating tissue wherein the treatment of the tissue results in a reduction in difference in mean tensile strength of the tissue between a circumferential and an axial orientation by at least 20% (e.g., 20-60% and all values and ranges therebetween) as compared to tissue treated by prior art processes.

Another non-limiting object of the present disclosure is the provision of a method for treating tissue wherein the treatment of the tissue reduces a difference in mean elongation of the tissue between a circumferential and an axial orientation by at least 25% (e.g., 25-80% and all values and ranges therebetween) as compared to tissue treated by prior art processes.

Another non-limiting object of the present disclosure is the provision of a method for treating tissue wherein the treatment of the tissue reduces a difference in mean stiffness of the tissue between a circumferential and an axial orientation by at least 25% (e.g., 25-70% and all values and ranges therebetween) as compared to tissue treated by prior art processes.

Another non-limiting object of the present disclosure is the provision of a method for treating tissue wherein the treatment of the tissue improves biocompatibility of the tissue as compared to tissue treated by prior art processes.

Another non-limiting object of the present disclosure is the provision of a method for treating tissue wherein the treatment of the tissue reduces cell lysis in the tissue by at least 50% (e.g., 50-100% and all values and ranges therebetween) as compared to tissue treated by prior art processes.

Another non-limiting object of the present disclosure is the provision of a method for treating tissue wherein the tissue is selected from the group consisting of a) bovine pericardium tissue, b) porcine, bovine, ovine, or other aortic or pulmonary valves and vascular tissues, c) human donor allografts, d) connective tissue matrices including porcine, equine, ovine and other xenogeneic or allogeneic pericardial tissues, e) omentum or other tissues of the digestive tract, f) skin, placenta, uterus, or tissues reconstructed in vitro from cells from such tissues, and h) ocular tissues including cornea and sclera.

Another non-limiting object of the present disclosure is the provision of a method for treating tissue wherein the tissue is used in a medical device; the medical device is selected from the group consisting of a) heart valves, b) valve leaflets, c) vascular grafts for peripheral, coronary and dialysis assess, and d) patches, strips, or buckles used to reinforce or repair soft tissues, hard tissues, cartilage, tendon, or cornea for organ repair and reinforcement.

Another non-limiting object of the present disclosure is the provision of a method for treating tissue wherein the tissue is cleaned by rinsing one or more times in distilled water, a saline solution and/or some other type of cleaning solution after one or more processing steps selected from the group consisting of a) providing the tissue, b) exposing the tissue to a fixation solution, c) optionally exposing the tissue to a bioburden reduction solution, and d) optionally exposing the tissue to an anti-calcification solution.

Another non-limiting object of the present disclosure is the provision of a method for treating tissue wherein the tissue is cut to a desired size.

Another non-limiting object of the present disclosure is the provision of a method for treating tissue wherein the fixation solution includes glutaraldehyde.

Another non-limiting object of the present disclosure is the provision of a method for treating tissue wherein the fixation solution includes glutaraldehyde and one or more compounds selected from the group consisting of saline, phosphate buffered saline, surfactants (e.g. Tween® 80), ethanol, aldehydes (e.g., formaldehyde, glutaraldehyde, dialdehyde starch), polyglycidyl ethers (e.g., Denacol 810), and/or heterologous bifunctional or multifunctional crosslinkers.

Another non-limiting object of the present disclosure is the provision of a method for treating tissue wherein the tissue is exposed to the fixation solution a sufficient time period to equilibrate within interstices of the tissue; the period of time is from 5 minutes to 48 hours.

Another non-limiting object of the present disclosure is the provision of a method for treating tissue wherein the bioburden solution includes i) a crosslinking agent (e.g., aldehydes, epoxies, carbodiimides, etc.), ii) a denaturing agent (e.g., alcohols, acidified ethers, ketones, glycols, etc.) and iii) a surfactant (e.g., anionic surfactants, alkyl sulfonic acid salts, alkylated phenoxypolyethoxy alcohols, Triton X-IOO, 114, 405, N-101, etc.); the bioburden solution has a different composition from the fixation solution.

Another non-limiting object of the present disclosure is the provision of a method for treating tissue wherein the tissue is exposed to the bioburden solution for 15 minutes to 2 weeks.

Another non-limiting object of the present disclosure is the provision of a method for treating tissue wherein the anti-calcification solution includes one or more of a) alcohols (ethanol, isopropanol, etc.), b) reducing agents (e.g., sodium borohydride, etc.), and/or c) capping solutions (e.g., ethanolamine, jeffamine, AOA, etc.).

Another non-limiting object of the present disclosure is the provision of a method for treating tissue wherein the tissue is exposed to the anti-calcification solution for 15 minutes to 48 hours.

Another non-limiting object of the present disclosure is the provision of a method for treating tissue wherein the dimensional stabilization solution includes one or more of polyols (e.g., glycerol, ethylene glycol, etc.) that are stable in atmosphere, aqueous solutions of polyols, and polyols diluted with alcohols (e.g., ethanol, isopropanol, etc.).

Another non-limiting object of the present disclosure is the provision of a method for treating tissue wherein the tissue is exposed to the dimensional stabilization solution for a time period sufficient to equilibrate within the interstices of the tissue; the time period is 15 minutes to 72 hours.

Another non-limiting object of the present disclosure is the provision of a method for treating tissue wherein the dimensional stabilization solution is removed from the tissue with use of alcohols and/or water.

Another non-limiting object of the present disclosure is the provision of a method for treating tissue wherein the dimensional stabilization solution is removed from the tissue with use of the thickening agent; the thickening agent includes one or more of polysaccharides (e.g., maltodextrin (d-glucose polysaccharide), guar gum (galactomannan polysaccharide), pectin (heteropolysaccharide), starches, etc.).

Another non-limiting object of the present disclosure is the provision of a method for treating tissue the step of sterilization includes the use of a sterilization gas (e.g., ethylene oxide, etc.).

Another non-limiting object of the present disclosure is the provision of a method for treating tissue component comprising: providing an animal tissue component that includes aqueous fluid within interstices of the animal tissue component; treating the animal tissue component with a dimensional stabilizer solution for a time sufficient to equilibrate within the interstices of the animal tissue component; removing the treated animal tissue component from the dimensional stabilizer solution after the dimensional stabilizer solution has equilibrated within the interstices of the animal tissue component; applying a thickening agent to exposed surfaces of the animal tissue component to remove residual dimensional stabilizer solution that remains on the animal tissue component; mechanically removing the thickening agent from the animal tissue component; storing the treated animal tissue component in a packaging or container that is optionally absent a liquid solution; and subjecting the packaged, the container and/or the treated animal tissue component to a sterilization process that is optionally absent a liquid.

Another non-limiting object of the present disclosure is the provision of a method for treating tissue component comprising: providing an animal tissue component that includes aqueous fluid within interstices of the animal tissue component; treating the animal tissue component with a dimensional stabilizer solution for a time sufficient to equilibrate within the interstices of the animal tissue component; adding a thickening agent into the dimensional stabilizer solution while the animal tissue component is on the dimensional stabilizer solution; removing the animal treated tissue from the dimensional stabilizer solution that includes the thickening agent; mechanically removing the thickening agent from the animal tissue component; storing the treated animal tissue component in a packaging or container that is optionally absent a liquid solution; and subjecting the packaged, the container and/or the treated animal tissue component to a sterilization process that is optionally absent a liquid.

Another non-limiting object of the present disclosure is the provision of a method for treating tissue component comprising: providing an animal tissue component that includes aqueous fluid within interstices; treating the tissue component with a treatment solution comprising a dimensional stabilizer and a thickening agent for a time sufficient to equilibrate within the interstices; removing the treated animal tissue component from treatment solution; mechanically removing the thickening agent/treatment solution from the treated animal tissue component; storing the treated tissue component in a container or a package optionally without solution; and subjecting the packaged, the container and/or the treated animal tissue component to a sterilization process that is optionally without a liquid.

Another non-limiting object of the present disclosure is the provision of a method for treating tissue component comprising: providing an animal tissue component that includes aqueous fluid within interstices of the animal tissue component; optionally cleaning the animal tissue component; optionally treating the animal tissue component to a bioburden reduction solution; optionally treating the animal tissue component to an anti-calcification solution; treating the animal tissue component with a dimensional stabilizer solution for a time sufficient to equilibrate within the interstices of the animal tissue component; removing the treated animal tissue component from the dimensional stabilizer solution after the dimensional stabilizer solution has equilibrated within the interstices of the animal tissue component; applying a thickening agent or an alcohol solution to exposed surfaces of the animal tissue component to remove residual dimensional stabilizer solution that remains on the animal tissue component; optionally mechanically removing the thickening agent, when used, from the animal tissue component; storing the treated animal tissue component in a packaging or container that is optionally absent a liquid solution; and subjecting the packaged, the container and/or the treated animal tissue component to a sterilization process that is optionally absent a liquid.

These and other advantages will become apparent to those skilled in the art upon the reading and following of this description.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 illustrates a prior art method for processing tissue to reduce calcification of the tissue.

FIG. 1A illustrates another prior art method for processing tissue to reduce calcification of the tissue.

FIG. 2 illustrates a method for processing tissue to reduce calcification of the tissue in accordance with the present disclosure.

FIG. 2A illustrates another method for processing tissue to reduce calcification of the tissue in accordance with the present disclosure.

FIG. 2B illustrates another method for processing tissue to reduce calcification of the tissue in accordance with the present disclosure.

FIG. 3 illustrates a piece of tissue and the axial and the circumferential axes of the tissue.

FIG. 4 is a comparison of the Tensile Strength of processed tissue along the axial and the circumferential axes that was processed tissue by a conventional processing method and by a method in accordance with the present disclosure.

FIG. 5 is a comparison of the Elongation of processed tissue along the axial and the circumferential axes that was processed by a conventional processing method and by a method in accordance with the present disclosure.

FIG. 6 is a comparison of the Stiffness of processed tissue along the axial and the circumferential axes that was processed by a conventional processing method and by a method in accordance with the present disclosure.

FIG. 7 is a comparison of the percentage of Cell Lysis of processed tissue that was processed by a conventional processing method and by a method in accordance with the present disclosure.

### DESCRIPTION OF NON-LIMITING EMBODIMENTS OF THE DISCLOSURE

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

The present disclosure is directed to a method for the treatment of tissue for use in a prosthetic valve. Non-limiting prosthetic valves includes heart valve, TAVR valve, aortic valve, mitral valve, tricuspid valve, pulmonary valve, etc. In one non-limiting embodiment, the prosthetic valve (e.g., heart valve, TAVR valve, mitral valve replacement, tricuspid valve replacement, pulmonary valve replacement, etc.) includes a radially collapsible and expandable frame and a leaflet structure that comprises a plurality of leaflets. In one non-limiting embodiment, there is provided a method for treating tissue to inhibit post implant calcification. The method is particularly useful in treating tissue for use in the forming of leaflets of heart valves. However, it will be appreciated that the tissue treatment process can be used on tissues for other applications. For example, the treated tissue can be used in heart valves; venous valves; blood vessels; ureter; tendon; dura mater; skin; pericardium; cartilage (e.g., meniscus); ligament; bone; intestine (e.g., intestinal wall); small intestinal submucosa (“SIS tissue”), and periostium. As such, the treated tissued can be used in various procedures such as a) the surgical replacement of diseased heart valves with prosthetic heart valves that includes the treated tissue, b) the repair or bypassing of blood vessels by implanting biological vascular grafts that include the treated tissue, c) the surgical replacement or repair of torn or deficient ligaments by implanting bioprosthetic ligaments that include the treated tissue, d) the repair, reconstruction, reformation, enhancement, bulking, ingrowth, reconstruction or regeneration of native tissues by implanting one or more biopolymeric or bioprosthetic tissue scaffolds that include the treated tissue, etc. The tissue can be obtained from a human cadaver or animal donor, and prepared for subsequent fixation and treatment. The tissue is typically harvested by surgical cutting or removal from its human cadaver or host animal. Thereafter, the tissue is typically trimmed or cut to size and optionally washed with sterile water, basic salt solution, saline or other suitable washing solution.

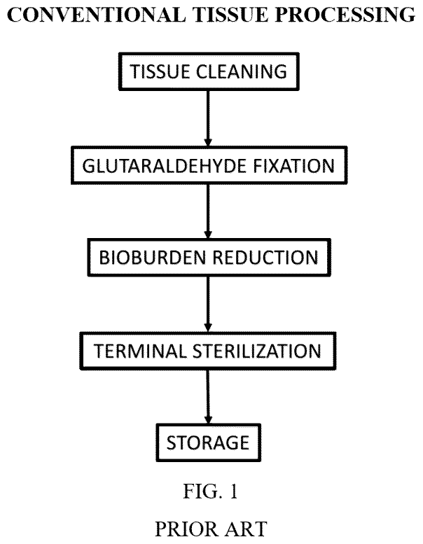

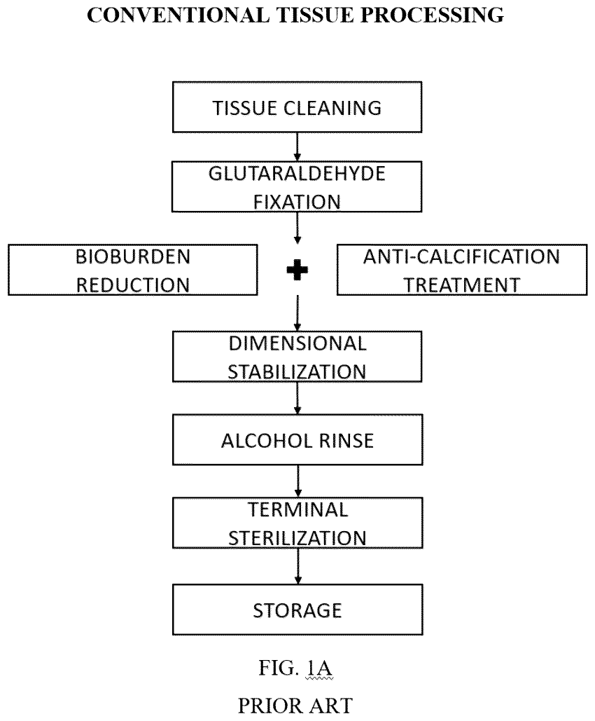

FIGS. 1 and 1A are flow charts that illustrate two prior art tissue processing processes. Such prior art tissue processing processes are similar to the tissue processing process disclosed in U.S. Pat. No. 7,622,276, which is fully incorporated herein.

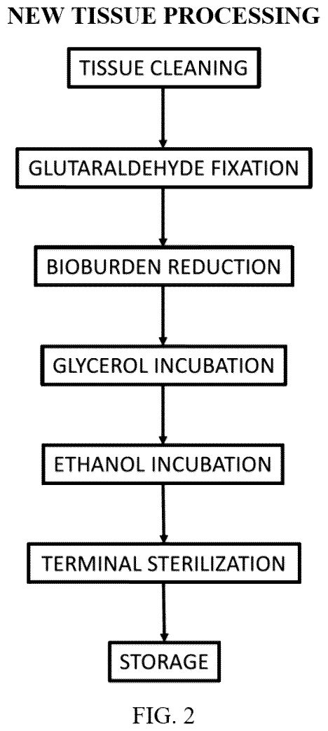

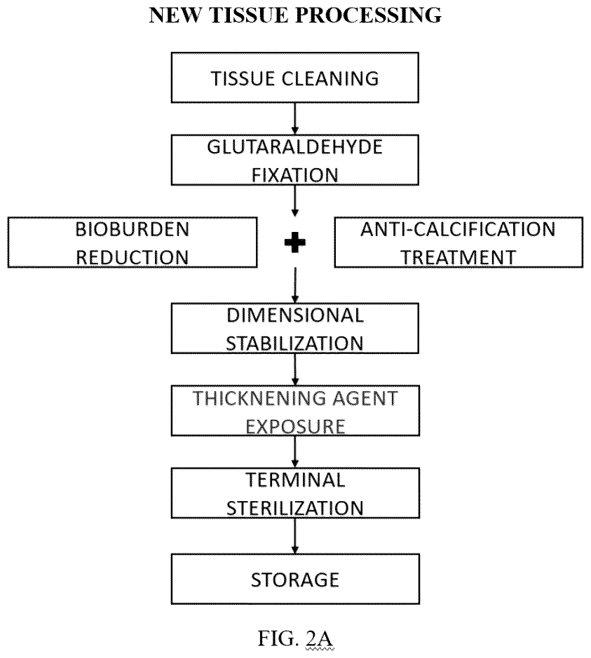

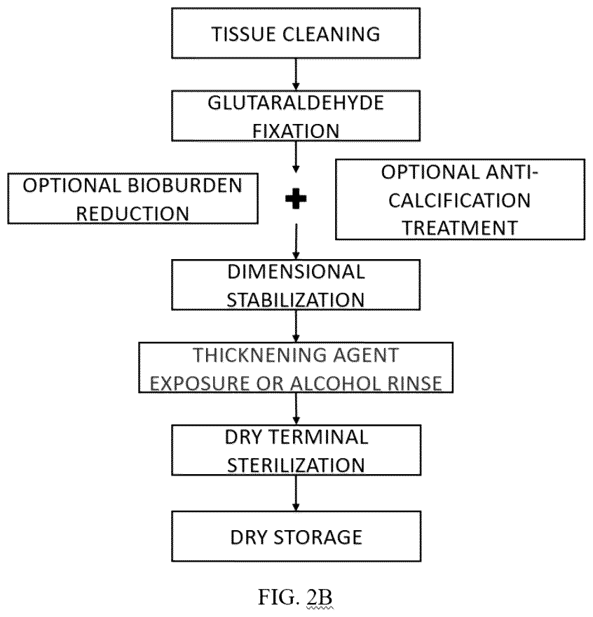

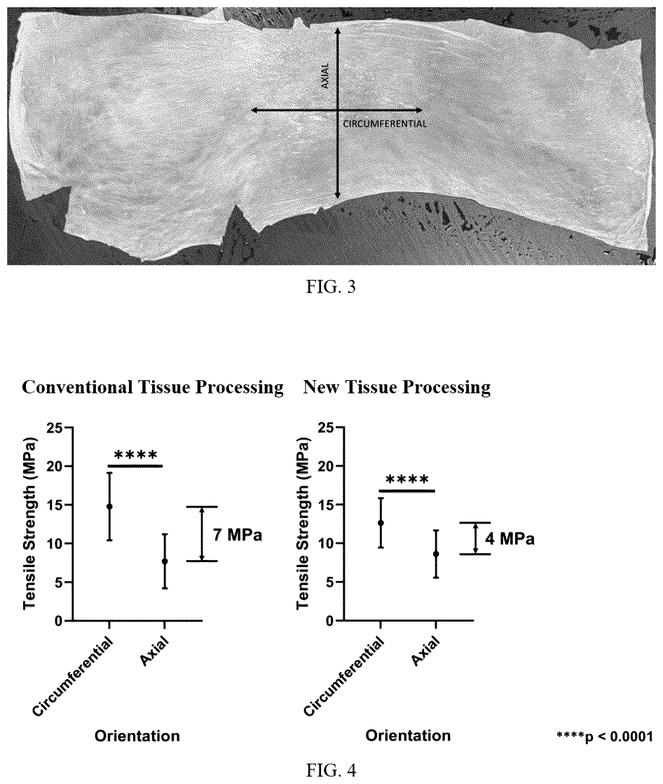

FIGS. 2-7 illustrate non-limiting methods for treating tissue and advantages of processed tissue in accordance with the present disclosure to processed tissue that is processed by prior art processes.

FIGS. 2, 2A and 2B are flow charts that illustrate three non-limiting tissue processing processes in accordance with the present disclosure.

FIG. 4 illustrates two graphs that provide a comparison of the Tensile Strength of processed tissue along the axial and the circumferential axes that was processed tissue by a conventional processing method as illustrated in FIGS. 1 and 1A and by a method in accordance with the present disclosure as illustrated in FIGS. 2, 2A and 2B. As illustrated in FIG. 4, the differential in Tensile Strength of the processed tissue along the axial and the circumferential axes that was processed tissue by the conventional processing method as illustrated in FIGS. 1 and 1A is greater than the differential in Tensile Strength of the processed tissue along the axial and the circumferential axes that was processed tissue by the method in accordance with the present disclosure as illustrated in FIGS. 2, 2A and 2B.

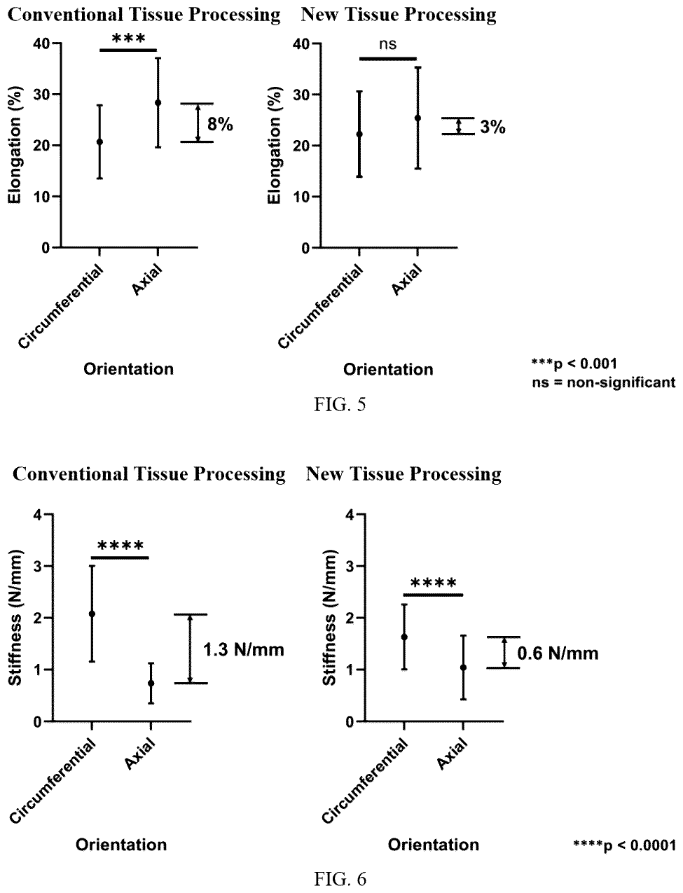

FIG. 5 illustrates two graphs that provide a comparison of the Elongation of processed tissue along the axial and the circumferential axes that was processed by a conventional processing method as illustrated in FIGS. 1 and 1A and by a method in accordance with the present disclosure as illustrated in FIGS. 2, 2A and 2B. As illustrated in FIG. 5, the differential in Elongation of the processed tissue along the axial and the circumferential axes that was processed tissue by the conventional processing method as illustrated in FIGS. 1 and 1A is greater than the differential in Tensile Strength of the processed tissue along the axial and the circumferential axes that was processed tissue by the method in accordance with the present disclosure as illustrated in FIGS. 2, 2A and 2B.

FIG. 6 illustrates two graphs that provide a comparison of the Stiffness of processed tissue along the axial and the circumferential axes that was processed by a conventional processing method as illustrated in FIGS. 1 and 1A and by a method in accordance with the present disclosure as illustrated in FIGS. 2, 2A and 2B. As illustrated in FIG. 6, the differential in Stiffness of the processed tissue along the axial and the circumferential axes that was processed tissue by the conventional processing method as illustrated in FIGS. 1 and 1A is greater than the differential in Tensile Strength of the processed tissue along the axial and the circumferential axes that was processed tissue by the method in accordance with the present disclosure as illustrated in FIGS. 2, 2A and 2B.

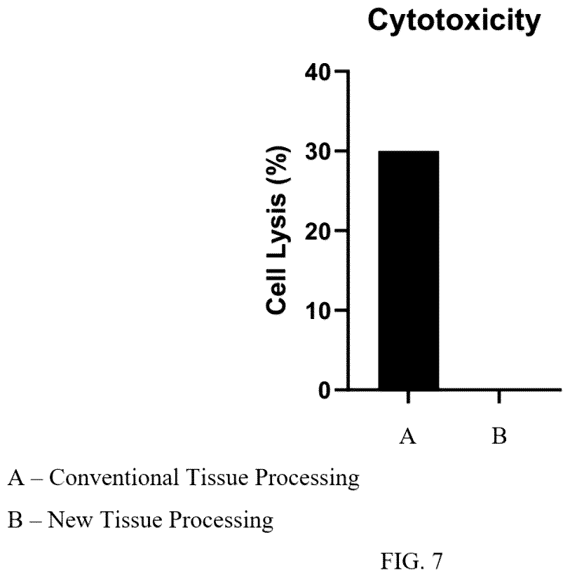

FIG. 7 is graph that provides a comparison of the percentage of Cell Lysis of processed tissue that was processed by a conventional processing method as illustrated in FIGS. 1 and 1A and by a method in accordance with the present disclosure as illustrated in FIGS. 2, 2A and 2B. As illustrated in FIG. 7, the percentage of Cell Lysis of the processed tissue that was processed tissue by the conventional processing method as illustrated in FIGS. 1 and 1A is greater than the percentage of Cell Lysis of the processed tissue that was processed tissue by the method in accordance with the present disclosure as illustrated in FIGS. 2, 2A and 2B.

The method for treating tissue in accordance with the present disclosure includes a) providing tissue (e.g., animal tissue, human tissue, etc.), b) optionally cleaning the tissue, c) exposing the tissue to a fixation solution, d) optionally exposing the tissue to a bioburden reduction solution, e) optionally exposing the tissue to an anti-calcification solution, f) exposing the tissue to a dimensional stabilizer solution, g) applying a thickening agent or alcohol to the tissue, h) optionally removing the thickening agent or alcohol from the tissue, i) optionally storing the treated tissue in a packaging or a container that is absent a liquid solution, and j) subjecting the packaged, container and/or tissue to a sterilization process.

Referring now to FIG. 2, there is illustrated one non-limiting tissue processing method in accordance with the present disclosure that includes a) providing tissue (e.g., animal tissue, human tissue, etc.), b) optionally cleaning the tissue, c) exposing the tissue to a fixation solution, d) optionally exposing the tissue to a bioburden reduction solution, e) optionally exposing the tissue to an anti-calcification solution, f) exposing the tissue to a dimensional stabilizer solution, g) applying alcohol to the tissue, h) optionally removing the alcohol from the tissue, i) optionally storing the treated tissue in a packaging or a container that is absent a liquid solution, and j) subjecting the packaged, container and/or tissue to a sterilization process.

Referring now to FIG. 2A, there is illustrated another non-limiting tissue processing method in accordance with the present disclosure that includes a) providing tissue (e.g., animal tissue, human tissue, etc.), b) optionally cleaning the tissue, c) exposing the tissue to a fixation solution, d) optionally exposing the tissue to a bioburden reduction solution, e) optionally exposing the tissue to an anti-calcification solution, f) exposing the tissue to a dimensional stabilizer solution, g) applying a thickening agent to the tissue, h) optionally removing the thickening agent from the tissue, i) optionally storing the treated tissue in a packaging or a container that is absent a liquid solution, and j) subjecting the packaged, container and/or tissue to a sterilization process.

The source of tissue that can be processed is non-limiting. Non-limiting types of tissue that can be used include bovine pericardium tissue; porcine, bovine, ovine, or other aortic or pulmonary valves and vascular tissues; human donor allografts; other sources of connective tissue matrices, including porcine, equine, ovine and other xenogeneic or allogeneic pericardial tissues; dura mater; omentum or other tissues of the digestive tract; skin, placenta, uterus, or tissues reconstructed in vitro from cells from such tissues; and ocular tissues including cornea and sclera. The processed tissue can be used in various types of medical device such as, but not limited to, heart valves and valve leaflets; vascular grafts for peripheral, coronary and dialysis asses s; patches, strips, or buckles used to reinforce or repair soft tissues, hard tissues, cartilage, tendon, cornea, or the like for organ repair and reinforcement for effective reconstruction procedures (including native valve reconstruction, valve annuloplasty and repair).

The tissue can be cleaned by rinsing the tissue one or more times (e.g., 1-5 times, etc.) in distilled water and/or a saline solution. Prior to or after the cleaning of the tissue, the tissue can be cut to a desired size for further processing.

The fixation solution includes glutaraldehyde. The fixation solution is used to stabilize the structure of the tissue for long-term implantation purposes. Generally, the tissue is exposed to the fixation solution for 5 minutes to 48 hours (and all values and ranges therebetween); however, longer exposure times can be used. The temperature of the fixation solution that is used on the tissue can be 4° C.-45° C. (and all values and ranges therebetween). The relative humidity about the tissue during the fixation step can be 5%-95% (and all values and ranges therebetween). Non-limiting examples of fixation solutions include a) pure glutaraldehyde, or b) a glutaraldehyde solution, which solution can include one or more of saline, phosphate buffered saline, surfactants (e.g. Tween® 80), ethanol, aldehydes (e.g., formaldehyde, glutaraldehyde, dialdehyde starch), polyglycidyl ethers (e.g., Denacol 810), and/or heterologous bifunctional or multifunctional crosslinkers. One non-limiting fixation solution includes glutaraldehyde and formaldehyde. The tissue is generally exposed to the fixation solution for a sufficient time period to equilibrate within the interstices of the tissue. As can be appreciated, the tissue can be exposed to the fixation solution in a single step, or can be exposed to the fixation solution two of more times (e.g., expose tissue to fixation solution, then remove tissue from the fixation solution, and then reexpose tissue to the fixation solution, and optionally rinsing the tissue after being remove from the fixation solution and prior to being reexposed to the fixation solution, etc.). After the tissue has been exposed to the fixation solution, the tissue can be optionally rinsed one or more times (e.g., 1-5 times, etc.). Such rinsing solution can include, but is not limited to, distilled water and/or saline.

The optional bioburden reduction step includes exposing the tissue to a bioburden solution of i) a crosslinking agent (e.g., aldehydes, epoxies, carbodiimides, etc.), ii) a denaturing agent (e.g., alcohols, acidified ethers, ketones, glycols, etc.) and iii) a surfactant (e.g., anionic surfactants, alkyl sulfonic acid salts, alkylated phenoxypolyethoxy alcohols, Triton X-IOO, 114, 405, N-101, etc.). Non-limiting bioburden reduction solution is disclosed in U.S. Pat. Nos. 4,885,005, 4,648,881, and 8,632,608 which are fully incorporated herein by reference. In one non-limiting embodiment, the bioburden reduction solution is a mixture of formaldehyde (e.g., 3-5 wt. %), ethanol (e.g., 19-25 wt. %), surfactant (e.g., Tween® 80 surfactant) (e.g., 0.8-2 wt. %) and the balance water. The tissue is generally exposed to the bioburden reduction solution for 15 minutes to 2 weeks (and all values and ranges therebetween). The temperature of the bioburden reduction solution that is used on the tissue can be 4° C.-45° C. (and all values and ranges therebetween). The relative humidity about the tissue during the bioburden reduction step can be 5%-95% (and all values and ranges therebetween). Generally, the composition of the bioburden reduction solution is different from the fixation solution. As can be appreciated, the tissue can be exposed to the bioburden reduction solution in a single step, or can be exposed to the bioburden reduction solution two of more times (e.g., expose tissue to bioburden reduction solution, then remove tissue from the bioburden reduction solution, and then reexpose tissue to the bioburden reduction solution, and optionally rinse the tissue after being removed from the bioburden reduction solution and prior to being reexposed to the bioburden reduction solution, etc.). After the completion of the bioburden reduction step, the tissue can be rinsed one or more times (e.g., 1-5 times) with a saline solution and/or distilled water or some other type of rinsing solution. The bioburden reduction step is used to minimize the microbial load of the tissue.

The tissue is optionally exposed to an anti-calcification treatment. The anti-calcification treatment is used to mitigate calcium deposition onto the tissue. The anti-calcification treatment performed before or after the step of exposing the tissue to the fixation solution. The anti-calcification treatment includes the step of a) exposing the tissued to one or more solutions that include alcohol rinses (ethanol, isopropanol, etc.), b) directing chemistry of crosslinking bonds in the tissue by exposure to reducing agents (e.g., sodium borohydride, etc.), and/or c) capping of residual aldehyde residues in the tissue by exposure to capping solutions (e.g., ethanolamine, jeffamine, AOA, etc.). The tissue is exposed to the anti-calcification solution for 15 minutes to 48 hours (and all values and ranges therebetween). The temperature of the anti-calcification solution that is used on the tissue can be 4° C.-45° C. (and all values and ranges therebetween). The relative humidity about the tissue during the anti-calcification step can be 5%-95% (and all values and ranges therebetween). As can be appreciated, the tissue can be exposed to the anti-calcification solution in a single step, or can be exposed to the anti-calcification solution two of more times (e.g., exposed tissue to anti-calcification solution, then remove tissue from the anti-calcification solution, and then reexpose tissue to the anti-calcification solution, and optionally rinsing the tissue after being removed from the anti-calcification solution and prior to being reexposed to the anti-calcification solution, etc.). After the tissue has been exposed to the anti-calcification treatment, the tissue can be exposed to one or more rinses with distilled water, saline solution, or some other type of rinsing solution.

The tissue is exposed to a dimensional stabilization treatment (also referred to as a Glycerol Incubation). The dimensional stabilization of the tissue is achieved via replacing the water content of the tissue interstices with a stable organic compound. During the dimensional stabilization treatment, the tissue is exposed to a solution that includes polyols (e.g., glycerol, ethylene glycol, etc.) that are stable in atmosphere. The solution can be formed of pure polyols, aqueous solutions of polyols, and polyols diluted with alcohols (e.g., ethanol, isopropanol, etc.). In one non-limiting embodiment, the composition of the dimensional stabilization solution is 5-100 vol. % of one or more polyols (and all values and ranges therebetween), 0-60 vol. % distilled water (and all values and ranges therebetween), and 0-60 vol. % of one or more alcohols (and all values and ranges therebetween). In another non-limiting embodiment, the composition of the dimensional stabilization solution is 5-100 vol. % glycerol (and all values and ranges therebetween), 0-60 vol. % distilled water (and all values and ranges therebetween), and 0-60 vol. % alcohol (and all values and ranges therebetween). The tissue is exposed to the dimensional stabilization solution for a time sufficient to equilibrate within the interstices of the tissue. In one non-limiting embodiment, the tissue is exposed to the dimensional stabilization solution for 15 minutes to 72 hours (and all values and ranges therebetween). The temperature of the dimensional stabilization solution that is used on the tissue can be 4° C.-45° C. (and all values and ranges therebetween). The relative humidity about the tissue during the dimensional stabilization step can be 5%-95% (and all values and ranges therebetween). As can be appreciated, the tissue can be exposed to the dimensional stabilization solution in a single step, or can be exposed to the dimensional stabilization solution two of more times (e.g., exposed tissue to dimensional stabilization solution, then remove tissue from the dimensional stabilization solution, and then reexpose tissue to the dimensional stabilization solution, and optionally rinsing the tissue after being removed from the dimensional stabilization solution and prior to being reexposed to the dimensional stabilization solution, etc.). After the tissue has been exposed to the dimensional stabilization solution for a desired period of time, the dimensional stabilization solution is removed from the tissue. In one non-limiting embodiment, the removal of the dimensional stabilization solution from the tissue is accomplished with the use of alcohols or water.

The tissue is exposed to Ethanol Incubation as illustrated in FIG. 2. The step Ethanol Incubation is an alternative step to the step of exposing the tissue to a thickening agent as illustrated in FIG. 2A. As can be appreciated, the Ethanol Incubation solution used in the Ethanol Incubation step can be 100% ethanol, a portion ethanol and one or more other types of alcohols (e.g., isopropanol, etc.), or one or more alcohols that does not include ethanol. In one non-limiting embodiment, the tissue is exposed to the Ethanol Incubation solution for 1 second to 12 hours (and all values and ranges therebetween). The temperature of the Ethanol Incubation solution that is used on the tissue can be 4° C.-45° C. (and all values and ranges therebetween). The relative humidity about the tissue during the Ethanol Incubation step can be 5%-95% (and all values and ranges therebetween). As can be appreciated, the tissue can be exposed to the Ethanol Incubation solution in a single step, or can be exposed to the Ethanol Incubation solution two of more times (e.g., exposed tissue to Ethanol Incubation solution, then remove tissue from the Ethanol Incubation solution, and then reexpose tissue to the Ethanol Incubation solution).

The tissue is optionally exposed to a thickening agent. When the tissue is exposed to the thickening agent, the step of Ethanol Incubation can be eliminated. Generally, the thickening agent is applied to the tissue after the dimensional stabilization step; however, the thickening agent can be added to the dimensional stabilization solution while the tissue is in the dimensional stabilization. When the thickening agent is added to the dimensional stabilization solution while the tissue in in the dimensional stabilization, the thicken agent is generally added to the dimensional stabilization solution after the dimensional stabilization solution has equilibrated within the interstices of the tissue; however, this is not required. The thickening agent is generally applied to a portion or all of the outer surface of the tissue. The thickening agent is used to remove a portion or all of prior solution treatments that remain on the tissue without use of solutions that include alcohols and/or water. Polyols that are used in the dimensional stabilization solution are highly viscous and coat the surface of the tissue. Generally, alcohol rinses of various composition, concentration, and duration were used to remove residual polyols from the tissue. However, alcohol-based rinses run the risk of dehydrating and potentially damaging the tissue. Also, alcohol solutions diluted in water run the risk of partially impregnating the tissue with water. The use of the thickening agent overcomes this past tissue processing limitations. The application of a thickening agent to the surface of the tissue is used to remove any residual polyols from the tissue without the need of alcohols or alcohol solutions. The thickening agent can include polysaccharides (e.g., maltodextrin powder, maltodextrin (d-glucose polysaccharide), guar gum (galactomannan polysaccharide), pectin (heteropolysaccharide), starches, etc.). During the exposure of the tissue to the thickening agent can be used in combination with alcohol and/or water. After the tissue has been exposed to the thickening agent, the thickening agent is mechanically removed from the tissue.

The tissue is stored in a container or package after the removal of the thickening agent from the tissue. Generally, the container or packaging is absent any solution, thus the tissue is dry packed in the container or packaging. Non-limiting packaging includes Tyvek/poly pouches.

The tissue is sterilized prior to, during and/or after being stored in a container or packaging. In one non-limiting embodiment, the tissue is sterilized by the use of a sterilization gas (e.g., ethylene oxide, etc.). As can be appreciated, other or alternative sterilization processes can be use. In one non-limiting embodiment, the sterilization of the tissue, packaging and/or container is accomplished with use of a liquid material.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed:

1. A method for treating tissue that includes a) providing tissue (e.g., animal tissue, human tissue, etc.), b) optionally cleaning the tissue, c) exposing the tissue to a fixation solution, d) optionally exposing the tissue to a bioburden reduction solution, e) optionally exposing the tissue to an anti-calcification solution, f) exposing the tissue to a dimensional stabilizer solution, g) applying a thickening agent or alcohol to the tissue, h) optionally removing the thickening agent or alcohol from the tissue, i) optionally storing the treated tissue in a packaging or a container that is optionally absent a liquid solution, and j) subjecting the packaged, container and/or tissue to a sterilization process that optionally does not include a liquid.

2. The method as defined in claim 1, wherein said treatment of said tissue reduces directional heterogeneity in material properties of said tissue as compared to tissue treated by prior art processes.

3. The method as defined in claim 1, wherein said treatment of said tissue results in a reduction in difference in mean tensile strength of said tissue between a circumferential and an axial orientation by at least 20% (e.g., 20-60% and all values and ranges therebetween) as compared to tissue treated by prior art processes.

4. The method as defined in claim 1, wherein said treatment of said tissue reduces a difference in mean elongation of said tissue between a circumferential and an axial orientation by at least 25% (e.g., 25-80% and all values and ranges therebetween) as compared to tissue treated by prior art processes.

5. The method as defined in claim 1, wherein said treatment of said tissue reduces a difference in mean stiffness of said tissue between a circumferential and an axial orientation by at least 25% (e.g., 25-70% and all values and ranges therebetween) as compared to tissue treated by prior art processes.

6. The method as defined in claim 1, wherein said treatment of said tissue improves biocompatibility of said tissue as compared to tissue treated by prior art processes.

7. The method as defined in claim 1, wherein said treatment of said tissue reduces cell lysis in said tissue by at least 50% (e.g., 50-100% and all values and ranges therebetween) as compared to tissue treated by prior art processes.

8. The method as defined in claim 1, wherein said tissue is selected from the group consisting of a) bovine pericardium tissue, b) porcine, bovine, ovine, or other aortic or pulmonary valves and vascular tissues, c) human donor allografts, d) connective tissue matrices including porcine, equine, ovine and other xenogeneic or allogeneic pericardial tissues, e) omentum or other tissues of the digestive tract, f) skin, placenta, uterus, or tissues reconstructed in vitro from cells from such tissues, and h) ocular tissues including cornea and sclera.

9. The method as defined in claim 1, wherein said tissue is used in a medical device; said medical device is selected from the group consisting of a) heart valves, b) valve leaflets, c) vascular grafts for peripheral, coronary and dialysis assess, and d) patches, strips, or buckles used to reinforce or repair soft tissues, hard tissues, cartilage, tendon, or cornea for organ repair and reinforcement.

10. The method as defined in claim 1, wherein said tissue is cleaned by rinsing one or more times in distilled water, a saline solution and/or some other type of cleaning solution after one or more processing steps selected from the group consisting of a) providing said tissue, b) exposing said tissue to a fixation solution, c) optionally exposing said tissue to a bioburden reduction solution, and d) optionally exposing said tissue to an anti-calcification solution.

11. The method as defined in claim 1, wherein said tissue is cut to a desired size.

12. The method as defined in claim 1, wherein said fixation solution includes glutaraldehyde.

13. The method as defined in claim 1, wherein said fixation solution includes glutaraldehyde and one or more compounds selected from the group consisting of saline, phosphate buffered saline, surfactants (e.g. Tween® 80), ethanol, aldehydes (e.g., formaldehyde, glutaraldehyde, dialdehyde starch), polyglycidyl ethers (e.g., Denacol 810), and/or heterologous bifunctional or multifunctional crosslinkers.

14. The method as defined in claim 1, wherein said tissue is exposed to said fixation solution a sufficient time period to equilibrate within interstices of said tissue; said period of time is from 5 minutes to 48 hours.

15. The method as defined in claim 1, wherein said bioburden solution includes i) a crosslinking agent (e.g., aldehydes, epoxies, carbodiimides, etc.), ii) a denaturing agent (e.g., alcohols, acidified ethers, ketones, glycols, etc.) and iii) a surfactant (e.g., anionic surfactants, alkyl sulfonic acid salts, alkylated phenoxypolyethoxy alcohols, Triton X-IOO, 114, 405, N-101, etc.); said bioburden solution has a different composition from said fixation solution.

16. The method as defined in claim 1, wherein said tissue is exposed to said bioburden solution for 15 minutes to 2 weeks.

17. The method as defined in claim 1, wherein said anti-calcification solution includes one or more of a) alcohols (ethanol, isopropanol, etc.), b) reducing agents (e.g., sodium borohydride, etc.), and/or c) capping solutions (e.g., ethanolamine, jeffamine, AOA, etc.).

18. The method as defined in claim 1, wherein said tissue is exposed to said anti-calcification solution for 15 minutes to 48 hours.

19. The method as defined in claim 1, wherein said dimensional stabilization solution includes one or more of polyols (e.g., glycerol, ethylene glycol, etc.) that are stable in atmosphere, aqueous solutions of polyols, and polyols diluted with alcohols (e.g., ethanol, isopropanol, etc.).

20. The method as defined in claim 1, wherein said tissue is exposed to said dimensional stabilization solution for a time period sufficient to equilibrate within said interstices of said tissue; said time period is 15 minutes to 72 hours.

21. The method as defined in claim 1, wherein said dimensional stabilization solution is removed from said tissue with use of alcohols and/or water.

22. The method as defined in claim 1, wherein said dimensional stabilization solution is removed from said tissue with use of said thickening agent; said thickening agent includes one or more of polysaccharides (e.g., maltodextrin (d-glucose polysaccharide), guar gum (galactomannan polysaccharide), pectin (heteropolysaccharide), starches, etc.).

23. The method as defined in claim 1, wherein said step of sterilization includes the use of a sterilization gas (e.g., ethylene oxide, etc.).

24. A method of preparing a tissue component comprising:
providing an animal tissue component that includes aqueous fluid within interstices of said animal tissue component;
treating said animal tissue component with a dimensional stabilizer solution for a time sufficient to equilibrate within said interstices of said animal tissue component;
removing said treated animal tissue component from said dimensional stabilizer solution after said dimensional stabilizer solution has equilibrated within said interstices of said animal tissue component;
applying a thickening agent to exposed surfaces of said animal tissue component to remove residual dimensional stabilizer solution that remains on said animal tissue component;
mechanically removing said thickening agent from said animal tissue component;
storing said treated animal tissue component in a packaging or container that is optionally absent a liquid solution; and
subjecting said packaged, said container and/or said treated animal tissue component to a sterilization process that is optionally absent a liquid.

25. The method as defined in claim 24, wherein said thickening agent includes one or more of polysaccharides (e.g., maltodextrin (d-glucose polysaccharide), guar gum (galactomannan polysaccharide, etc.), pectin (heteropolysaccharide) and/or starches.

26. The method as defined in claim 24, wherein said thickening agent is applied to said tissue in the presence of alcohol and/or water.

27. The method as defined in claim 24, wherein said step of sterilization includes exposing said packaged, said container and/or said treated animal tissue component to ethylene oxide gas.

28. A method of preparing a tissue component comprising:
providing an animal tissue component that includes aqueous fluid within interstices of said animal tissue component;
treating said animal tissue component with a dimensional stabilizer solution for a time sufficient to equilibrate within said interstices of said animal tissue component;
adding a thickening agent into said dimensional stabilizer solution while said animal tissue component is on said dimensional stabilizer solution;
removing said animal treated tissue from said dimensional stabilizer solution that includes said thickening agent;
mechanically removing said thickening agent from said animal tissue component;
storing said treated animal tissue component in a packaging or container that is optionally absent a liquid solution; and
subjecting said packaged, said container and/or said treated animal tissue component to a sterilization process that is optionally absent a liquid.

29. The method as defined in claim 28, wherein said thickening agent includes one or more of polysaccharides (e.g., maltodextrin (d-glucose polysaccharide), guar gum (galactomannan polysaccharide, etc.), pectin (heteropolysaccharide) and/or starches.

30. The method as defined in claim 28, wherein said thickening agent is applied to said tissue in the presence of alcohol and/or water.

31. The method as defined in claim 28, wherein said step of sterilization includes exposing said packaged, said container and/or said treated animal tissue component to ethylene oxide gas.

32. A method of preparing a tissue component comprising:
providing an animal tissue component that includes aqueous fluid within interstices;
treating said tissue component with a treatment solution comprising a dimensional stabilizer and a thickening agent for a time sufficient to equilibrate within the interstices;
removing said treated animal tissue component from treatment solution;
mechanically removing said thickening agent/treatment solution from said treated animal tissue component;
storing said treated tissue component in a container or a package optionally without solution; and
subjecting said packaged, said container and/or said treated animal tissue component to a sterilization process that is optionally without a liquid.

33. The method as defined in claim 32, wherein said thickening agent includes one or more of polysaccharides (e.g., maltodextrin (d-glucose polysaccharide), guar gum (galactomannan polysaccharide, etc.), pectin (heteropolysaccharide) and/or starches.

34. The method as defined in claim 32, wherein said thickening agent is applied to said tissue in the presence of alcohol and/or water.

35. The method as defined in claim 32, wherein said step of sterilization includes exposing said packaged, said container and/or said treated animal tissue component to ethylene oxide gas.

36. A method of preparing a tissue component comprising:
providing an animal tissue component that includes aqueous fluid within interstices of said animal tissue component;
optionally cleaning said animal tissue component;
optionally treating said animal tissue component to a bioburden reduction solution;
optionally treating said animal tissue component to an anti-calcification solution;
treating said animal tissue component with a dimensional stabilizer solution for a time sufficient to equilibrate within said interstices of said animal tissue component;
removing said treated animal tissue component from said dimensional stabilizer solution after said dimensional stabilizer solution has equilibrated within said interstices of said animal tissue component;
applying a thickening agent or an alcohol solution to exposed surfaces of said animal tissue component to remove residual dimensional stabilizer solution that remains on said animal tissue component;
optionally mechanically removing said thickening agent, when used, from said animal tissue component;
storing said treated animal tissue component in a packaging or container that is optionally absent a liquid solution; and
subjecting said packaged, said container and/or said treated animal tissue component to a sterilization process that is optionally absent a liquid.
